(19) United States
(12) Patent Application Publication
(10) Pub. No.: US 2025/0199327 A1
(43) Pub. Date: Jun. 19, 2025

(54) DISPLAY APPARATUS AND METHOD INCORPORATING GAZE MOVEMENT-BASED STABILIZATION

(71) Applicant: Varjo Technologies Oy, Helsinki (FI)

(72) Inventors: Mikko Strandborg, Hangonkylä (FI); Mikko Ollila, Tampere (FI)

(73) Assignee: Varjo Technologies Oy, Helsinki (FI)

(21) Appl. No.: 18/543,178

(22) Filed: Dec. 18, 2023

(51) Int. Cl. G02B 27/64; G02B 27/00; G06F 3/01

(52) U.S. Cl. CPC G02B 27/64; G02B 27/0093; G06F 3/013

(57) ABSTRACT

Disclosed is a method including detecting a movement of a user's gaze by processing gaze-tracking data, collected by a gaze-tracking means of a display apparatus; when the movement of the user's gaze is detected, determining a compensatory movement which when implemented by an image stabilization means of the display apparatus, shifts visual content displayed on at least one display of the display apparatus, according to the movement of the user's gaze; and generating a first drive signal for controlling the image stabilization means to implement the compensatory movement, during a frame display time.

### TECHNICAL FIELD

The present disclosure relates to methods incorporating gaze movement-based stabilization. Moreover, the present disclosure relates to display apparatuses incorporating gaze movement-based stabilization.

### BACKGROUND

Conventionally, in applications where a user is viewing any visual data being displayed on a display screen, any movement of the user's eyes causes the visual data to appear blurry to the user. As a result, such blurriness in viewing the visual data creates an unpleasant viewing experience for the user. However, there exists present solutions for image stabilization which moves the visual data displayed on the display screen to remove any blurriness caused in viewing the visual data.

Although, the present solutions for image stabilization fail to precisely move the visual data displayed on the display screen according to the movement of the user's eyes. As a result, a quality of viewing experience of the user significantly reduces.

Therefore, in light of the foregoing discussion, there exists a need to overcome the aforementioned drawbacks.

### SUMMARY

The aim of the present disclosure is to provide a method and a display apparatus to avoid blurriness in viewing a visual content during movement of a user's gaze. The aim of the present disclosure is achieved by a method and a display apparatus for incorporating gaze movement-based stabilization as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is a flowchart depicting steps of a method, in accordance with an embodiment of the present disclosure;

FIG. 2 illustrates shifting of a visual content displayed on at least one display, in accordance with an embodiment of the present disclosure;

FIG. 3 illustrates a display apparatus, in accordance with an embodiment of the present disclosure; and

FIG. 4 illustrates an optical element arranged on an optical path between at least one display and a user's eye, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method comprising:
detecting a movement of a user's gaze by processing gaze-tracking data, collected by a gaze-tracking means of a display apparatus;
when the movement of the user's gaze is detected, determining a compensatory movement which when implemented by an image stabilization means of the display apparatus, shifts visual content displayed on at least one display of the display apparatus, according to the movement of the user's gaze; and
generating a first drive signal for controlling the image stabilization means to implement the compensatory movement, during a frame display time.

The present disclosure provides an aforementioned method. The method precisely shifts the visual content displayed on the at least one display according to the movement of the user's gaze. Thus, the method effectively removes any blurriness caused in viewing the visual content on the at least one display due to the movement of the user's gaze. Moreover, the method enhances an overall viewing experience of the user.

In a second aspect, the present disclosure provides a display apparatus comprising:
a gaze-tracking means;
an image stabilization means;
at least one display; and
at least one processor configured to:
   detect a movement of a user's gaze by processing gaze-tracking data, collected by the gaze-tracking means;
   when the movement of the user's gaze is detected, determine a compensatory movement which when implemented by the image stabilization means, shifts visual content displayed on the at least one display, according to the movement of the user's gaze; and
   generate a first drive signal for controlling the image stabilization means to implement the compensatory movement, during a frame display time.

The present disclosure provides an aforementioned display apparatus. The display apparatus precisely shifts the visual content displayed on the at least one display according to the movement of the user's gaze. Thus, the display apparatus effectively removes any blurriness caused in viewing the visual content on the at least one display due to the movement of the user's gaze. Moreover, the display apparatus enhances an overall viewing experience of the user.

Throughout the present disclosure, the movement of the user's gaze refers to a change in position of a gaze point of user's eyes. Optionally, the movement of the user's gaze is one of: a smooth pursuit movement, a saccadic movement, a Vestibulo-Ocular Reflex (VOR) movement. Optionally, the movement of the user's gaze is the smooth pursuit movement in that scenario when the user's eyes are tracking a moving object smoothly and continuously. Optionally, the movement of the user's gaze is the saccadic movement in that scenario when the user's eyes are scanning a surrounding environment, which causes the gaze point of the user's eyes to shift from one position to another position rapidly. Optionally, the movement of the user's gaze is the VOR movement in that scenario when the user's eyes move in an opposite direction to a direction of movement of user's head, to ensure a visual stability.

Notably, the method comprises detecting the movement of the user's gaze while the user is wearing the display apparatus. Throughout the present disclosure, the term “display apparatus” refers to specialized equipment that is configured to present an extended-reality (XR) environment to the user when the display apparatus in operation is worn by the user on his/her head. In such an instance, the display apparatus acts as a device (for example, such as an XR headset, a pair of XR glasses, and the like) that is operable to present a visual scene of the XR environment to the user. Throughout the present disclosure, the term “extended-reality” encompasses virtual reality (VR), augmented reality (AR), mixed reality (MR), and the like. It will be appreciated that the movement of the user's gaze occurs in the XR environment that is viewed by the display apparatus.

Throughout the present disclosure, the term “gaze-tracking data” refers to information collected by the gaze-tracking means that is indicative of gaze directions of the user's eyes. Optionally, the gaze-tracking data comprises at least one of: the gaze directions of the user's eyes, a gaze vector indicative of at least one of: a gaze velocity, a gaze acceleration. Herein, the gaze point of the user's eyes is determined at a point where the gaze directions of the user's eyes converge, which makes the gaze-tracking data also indicative of the gaze point of the user's eyes. Optionally, the change in the gaze point of the user's eyes is indicative of the at least one of: the gaze velocity, the gaze acceleration. It will be appreciated that the gaze-tracking means of the display apparatus are well-known in the art.

Notably, for detecting the movement of the user's gaze, the gaze-tracking data is processed as the gaze-tracking data is indicative of any change in the gaze point of the user's eyes. It will be appreciated that the movement of the user's gaze is detected when the at least one of: the gaze velocity, the gaze acceleration is non-zero, which indicates that the gaze point of the user's eyes is moving from one position to another position. Optionally, when processing the gaze-tracking data, the at least one processor is further configured to determine an average of at least one of: the gaze velocity, the gaze acceleration, over a predefined time period. It will be appreciated that while processing the gaze-tracking data, the at least one processor tracks the gaze point of the user's eyes to determine how the gaze point of the user's eyes is changing its position and subsequently, determine what is the movement of the user's gaze.

Throughout the present disclosure, the term “visual content” refers to a visual representation of the XR environment that is viewed by the user on the at least one display of the display apparatus while wearing the display apparatus. Notably, the movement of the user's gaze causes the user to experience a blurriness in viewing the visual content on the at least one display of the display apparatus. Subsequently, to maintain a consistent viewing experience for the user in viewing the visual content even when the user's gaze is moving, the visual content needs to be shifted on the at least one display according to the movement of the user's gaze. Throughout the present disclosure, the term “image stabilization means” refers to a device that causes the shifting of the visual content. Notably, the visual content displayed on the at least one display is shifted by making a compensatory movement in the visual content implemented by the image stabilization means. Throughout the present disclosure, the term “compensatory movement” refers to that movement in the visual content displayed on the at least one display, implemented by the image stabilization means which shifts the visual content according to the movement of the user's gaze to compensate the blurriness caused in viewing the visual content due to the movement of the user's gaze. It will be appreciated that the compensatory movement is determined according to the movement of the user's gaze. In other words, the compensatory movement is determined such that the image stabilization means is able to shift the visual content in that direction which removes the blurriness caused in viewing the visual content by the movement of the user's gaze.

Optionally, the image stabilization means is implemented as a wobulator, and wherein controlling the wobulator to implement the compensatory movement comprises one of:
physically moving at least one of: the at least one display, an optical element arranged on an optical path between the at least one display and a user's eye, an image sensor of an imaging system for the display apparatus, a lens of the imaging system, such that the visual content is shifted in a direction that is different from a direction of the movement of the user's gaze; or
optically steering light such that the visual content is shifted in a direction that is different from a direction of the movement of the user's gaze.

Throughout the present disclosure, the term “wobulator” refers to a device that is capable of performing sub-pixel shifts. The term “sub-pixel shift” refers to a pixel-level movement (namely, a pixel-level shifting) of the image sensor in a particular direction for shifting the visual content displayed on the at least one display. The wobulators are well-known in the art. Optionally, a given sub-pixel shift could be performed, for example, by physically moving the at least one of: the at least one display, the optical element arranged on the optical path between the at least one display and the user's eye, the image sensor of the imaging system for the display apparatus, the lens of the imaging system by a given step size in a particular direction, or by optically steering the light (incoming towards the image sensor or outgoing from the at least one display towards the user's eyes) by a given step size in a particular direction, which causes the visual content to be shifted in the direction that is different from the direction of the movement of the user's gaze. The at least one of: the at least one display, the optical element arranged on the optical path between the at least one display and the user's eye, the image sensor of the imaging system for the display apparatus, the lens of the imaging system could be physically moved (namely, tilted and/or shifted) by the wobulator, for example, by way of using an actuator. The optical steering could, for example, be done by way of using a liquid crystal device, a mems-actuated soft polymer, a micromirror, a lens, a liquid lens, adaptive optics and the like. In this regard, the direction that is different from the direction of the movement of the user's gaze refers to any direction which is not identical to the direction of the movement of the user's gaze. Notably, shifting the visual content in the direction different from the direction of the movement of the user's gaze enables to provide a compensation effect to the blurriness caused in viewing the visual content due to the movement of the user's gaze. A technical effect of the image stabilization means being implemented as the wobulator is that the visual content displayed on the at least one display is shifted precisely according to the movement of the user's gaze which enhances the overall viewing experience of the user.

Optionally, the image stabilization means is implemented as a controllable lens, and wherein controlling the controllable lens to implement the compensatory movement comprises adjusting a position of the controllable lens such that the visual content is shifted in a direction that is different from a direction of the movement of the user's gaze. Throughout the present disclosure, the term “controllable lens” refers to that optical lens, for which at least a position can be adjusted. Optionally, the controllable lens can be also adjusted by adjusting at least one of: a focal length of the controllable lens, a shape of the controllable lens, a distance between elements of the controllable lens, a distance between elements of the controllable lens, an aperture of the controllable lens, a property of an active material of the controllable lens. Optionally, the controllable lens is arranged as a part of an imaging system in the display apparatus, that generates the visual content on the at least one display of the display apparatus. Alternatively, the controllable lens is arranged in an optical path between the at least one display and a user's eye. Subsequently, adjusting the position of the controllable lens shifts a position where the visual content is generated in a 2-Dimensional (2-D) plane on the at least one display towards the direction that is different from the direction of the movement of the user's gaze. Notably, shifting the visual content in the direction that is different from the direction of the movement of the user's gaze enables to provide a compensation effect to the blurriness caused in viewing the visual content due to the movement of the user's gaze. A technical effect of the image stabilization means being implemented as the controllable lens is that the image stabilization means is able to precisely implement the compensatory movement.

Optionally, the image stabilization means is implemented as a metalens, and wherein controlling the metalens to implement the compensatory movement comprises adjusting a position of the metalens such that the visual content is shifted in a direction that is different from a direction of the movement of the user's gaze. Throughout the present disclosure, the term “metalens” refers to an optical lens that is made up of nanoparticles (for example, silicon). Optionally, the metalens is arranged as a part of an imaging system in the display apparatus, that generates the visual content on the at least one display of the display apparatus. Alternatively, the metalens is arranged in an optical path between the at least one display and a user's eye. Subsequently, adjusting the position of the metalens shifts a position where the visual content is generated in a 2-Dimensional (2-D) plane on the at least one display towards the direction that is different from the direction of the movement of the user's gaze. Notably, shifting the visual content in the direction that is different from the direction of the movement of the user's gaze enables to provide a compensation effect to the blurriness caused in viewing the visual content due to the movement of the user's gaze. A technical effect of the image stabilization means being implemented as the metalens is that the image stabilization means becomes lightweight and easy to integrate into the display apparatus.

Optionally, the image stabilization means is implemented as a liquid crystal-based element arranged on an optical path between the at least one display and the user's eyes, and wherein controlling the liquid crystal-based element to implement the compensatory movement comprises optically steering light emanating from the at least one display and going towards the user's eyes, such that the visual content is shifted in a direction that is different from a direction of the movement of the user's gaze. Throughout the present disclosure, the term “liquid crystal-based element” refers to that optical element which is made from liquid crystal materials that can manipulate light in various ways. It will be appreciated that arranging the liquid crystal-based element on the optical path between the at least one display and the user's eye enables the liquid crystal-based element to manipulate the light emanating from the at least one display and going towards the user's eyes and control a position at which the visual content appears to be on the at least one display to the user. Subsequently, optically steering (i.e., changing a direction) the light emanating from the at least one display and going towards the user's eyes, enables to shift the position at which the visual content appears to be on the at least one display to the user towards the direction that is different from the direction of the movement of the user's gaze. Notably, shifting the visual content in the direction that is different from the direction of the movement of the user's gaze enables to provide a compensation effect to the blurriness caused in viewing the visual content due to the movement of the user's gaze. A technical effect of the image stabilization means being implemented as the liquid crystal-based element is that the image stabilization means is able to precisely shift the visual content in the direction that is different from the direction of the movement of the user's gaze.

Throughout the present disclosure, the term “first drive signal” refers to that signal which drives the movement of the image stabilization means to implement the compensatory movement. Optionally, the first drive signal could be a piezoelectric force, an electromagnetic force, a mechanical torque, an electric current, a hydraulic pressure, a pneumatic pressure or similar. Throughout the present disclosure, the term “frame display time” refers to that duration of time for which a single frame of the visual content is displayed on the at least one display. Notably, the first drive signal for controlling the image stabilization means to implement the compensatory movement is generated during the frame display time as the visual content is displayed on the at least one display only for the duration of the frame display time and thus, the compensation movement needs to be implemented only for the duration of the frame display time. Optionally, the frame display time is dependent on a frame rate and a duty cycle of the at least one display. Subsequently, generating the first drive signal for controlling the image stabilization means to implement the compensatory movement during the frame display time, ensures that the visual content displayed on the at least one display is precisely shifted according to the movement of the user's gaze, for the duration of the frame display time.

Optionally, when the movement of the user's gaze is not detected, generating a second drive signal for controlling the image stabilization means to implement a non-compensatory movement during a display-off time, wherein the non-compensatory movement, when implemented by the image stabilization means, moves the visual content to a predefined default position. Throughout the present disclosure, the term “display-off time” refers to that duration for which the at least one display is inactive or turned-off. Notably, since the visual content is not visible on the at least one display during the display-off time, when the movement of the user's gaze is also not detected, then the visual content need not to be shifted and instead moved to the predefined default position during the display-off time. Throughout the present disclosure, the term “predefined default position” refers to an original position at which the visual content was displayed on the at least one display, prior to the shifting of the visual content due to the movement of the user's gaze. Notably, moving the visual content to the predefined default position during the display-off time makes the movement of the visual content to the predefined default position unnoticeable to the user. Throughout the present disclosure, the term “non-compensatory movement” refers to that movement implemented for the image stabilization means which causes the image stabilization means to move the visual content to the predefined default position. Throughout the present disclosure, the term “second drive signal” refers to that signal which drives the movement of the image stabilization means to implement the non-compensatory movement. Optionally, the second drive signal could be a piezoelectric force, an electromagnetic force, a mechanical torque, an electric current, a hydraulic pressure, a pneumatic pressure or similar. A technical effect is that the visual content is successfully moved to the predefined default position in a reset state during the display-off time, so that moving the visual content to the predefined default position is not perceivable by the user.

Optionally, when the movement of the user's gaze is not detected, generating a third drive signal for controlling the image stabilization means to implement a non-compensatory movement during a display-off time, wherein the non-compensatory movement, when implemented by the image stabilization means, moves the visual content to a position that lies in an opposite direction to the movement of the user's gaze and is at a distance that is equal to twice of a magnitude of the movement of the user's gaze. In this regard, moving the visual content to the position that lies in the opposite direction to the movement of the user's gaze and at the distance that is equal to twice of the magnitude of the movement of the user's gaze during the display-off time, enables to maximize an amount of movement available for shifting the visual content according to the movement of the user's gaze. For example, if the movement of the user's gaze is 10 pixels in a certain direction, then the visual content is moved to the position that is 20 pixels in the opposite direction to the movement of the user's gaze. Throughout the present disclosure, the term “third drive signal” refers to that signal which drives the movement of the image stabilization means to implement the non-compensatory movement to move the visual content to the position that lies in the opposite direction to the movement of the user's gaze and at the distance that is equal to twice of the magnitude of the movement of the user's gaze. Optionally, the third drive signal could be a piezoelectric force, an electromagnetic force, a mechanical torque, an electric current, a hydraulic pressure, a pneumatic pressure or similar. A technical effect is that the amount of movement available for shifting the visual content according to the movement of the user's gaze is maximized.

The present disclosure also relates to the display apparatus as described above. Various embodiments and variants disclosed above, with respect to the aforementioned method, apply mutatis mutandis to the display apparatus.

Throughout the present disclosure, the term “processor” refers to computational element that is operable to execute instructions of the display apparatus. It will be appreciated that the term “at least one processor” refers to “one processor” in some implementations, and “a plurality of processors” in other implementations. Examples of the at least one processor include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the at least one processor may refer to one or more individual processors, processing devices and various elements associated with a processing device that may be shared by other processing devices. Additionally, one or more individual processors, processing devices and elements are arranged in various architectures for responding to and processing the instructions that execute the at least one server.

Optionally, the at least one processor is further configured to:
when the movement of the user's gaze is not detected, generate a second drive signal to control the image stabilization means to implement a non-compensatory movement during a display-off time, wherein the non-compensatory movement, when implemented by the image stabilization means, moves the visual content to a predefined default position. A technical effect is that the visual content is successfully moved to the predefined default position in a reset state during the display-off time, so that moving the visual content to the predefined default position is not perceivable by the user.

Optionally, the at least one processor is further configured to:
when the movement of the user's gaze is not detected, generate a third drive signal to control the image stabilization means to implement a non-compensatory movement during a display-off time, wherein the non-compensatory movement, when implemented by the image stabilization means, moves the visual content to a position that lies in an opposite direction to the movement of the user's gaze and is at a distance that is equal to twice of a magnitude of the movement of the user's gaze. A technical effect is that an amount of movement available for shifting the visual content according to the movement of the user's gaze is maximized.

Optionally, the image stabilization means is implemented as a wobulator, and wherein to control the wobulator to implement the compensatory movement, the at least one processor is configured to:
physically move at least one of: the at least one display, an optical element arranged on an optical path between the at least one display and a user's eye, an image sensor of an imaging system for the display apparatus, a lens of the imaging system, such that the visual content is shifted in a direction that is different from a direction of the movement of the user's gaze; or
optically steer light such that the visual content is shifted in a direction that is different from a direction of the movement of the user's gaze.

In this regard, the technical effect of the image stabilization means being implemented as the wobulator is that the visual content displayed on the at least one display is shifted precisely according to the movement of the user's gaze which enhances the overall viewing experience of the user.

Optionally, the image stabilization means is implemented as a controllable lens, and wherein to control the controllable lens to implement the compensatory movement, the at least one processor is further configured to adjust a position of the controllable lens such that the visual content is shifted in a direction that is different from a direction of the movement of the user's gaze. A technical effect of the image stabilization means being implemented as the controllable lens is that the image stabilization means is able to precisely implement the compensatory movement.

Optionally, the image stabilization means is implemented as a metalens, and wherein to control the metalens to implement the compensatory movement, the at least one processor is further configured to adjust a position of the metalens such that the visual content is shifted in a direction that is different from a direction of the movement of the user's gaze. A technical effect of the image stabilization means being implemented as the metalens is that the image stabilization means becomes lightweight and easy to integrate into the display apparatus.

Optionally, the image stabilization means is implemented as a liquid crystal-based element arranged on an optical path between the at least one display and the user's eyes, and wherein to control the liquid crystal-based element to implement the compensatory movement, the at least one processor is further configured to optically steer light emanating from the at least one display and going towards the user's eyes, such that the visual content is shifted in a direction that is different from a direction of the movement of the user's gaze. A technical effect of the image stabilization means being implemented as the liquid crystal-based element is that the image stabilization means is able to precisely shift the visual content in the direction that is different from the direction of the movement of the user's gaze.

### DETAILED DESCRIPTION OF THE DRAWINGS

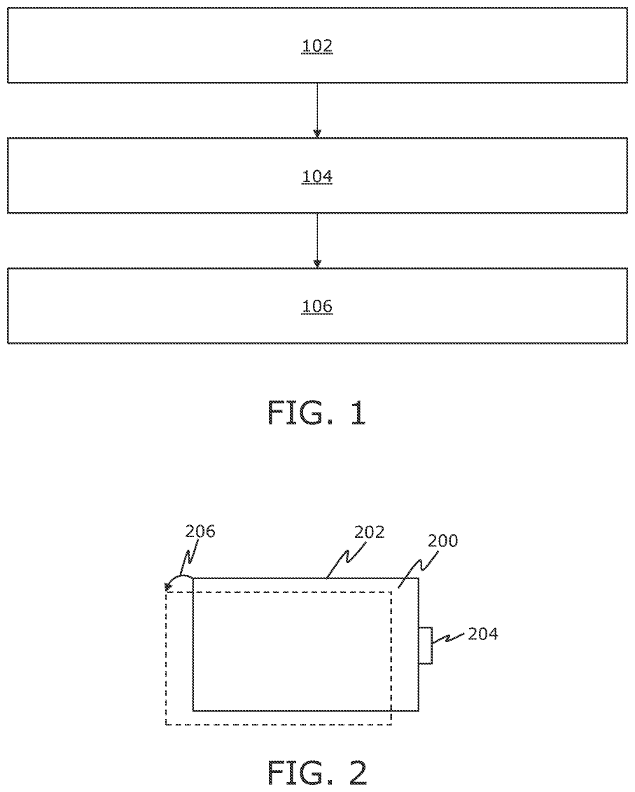

Referring to FIG. 1, is a flowchart depicting steps of a method, in accordance with an embodiment of the present disclosure. At step 102, a movement of a user's gaze is detected by processing gaze-tracking data, collected by a gaze-tracking means of a display apparatus. At step 104, when the movement of the user's gaze is detected, a compensatory movement is determined which, when implemented by an image stabilization means of the display apparatus, shifts visual content displayed on at least one display of the display apparatus, according to the movement of the user's gaze. At step 106, a first drive signal for controlling the image stabilization means to implement the compensatory movement, during a frame display time, is generated.

The aforementioned steps are only illustrative and other alternatives can also be provided where one or more steps are added, one or more steps are removed, or one or more steps are provided in a different sequence without departing from the scope of the claims.

Referring to FIG. 2, it illustrates shifting of a visual content 200 displayed on at least one display 202, in accordance with an embodiment of the present disclosure. As shown, the visual content 200 is displayed on the at least one display 202. Herein, a compensatory movement implemented by an image stabilization means 204 shifts the visual content 200 in a direction 206 that is different from a direction of movement of user's gaze.

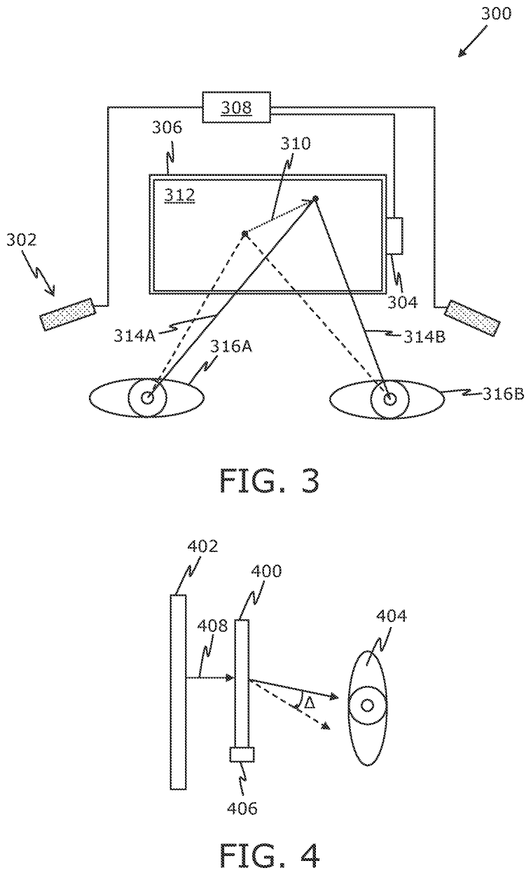

Referring to FIG. 3, it illustrates a display apparatus 300, in accordance with an embodiment of the present disclosure. As shown, the display apparatus 300 comprises a gaze-tracking means 302 (depicted as dotted hatch), an image stabilization means 304, at least one display 306 and at least one processor 308. The at least one processor 308 is configured to detect a movement 310 of a user's gaze by processing gaze-tracking data (wherein the gaze-tracking data comprises data related to a first gaze direction 314A of a first eye 316A and a second gaze direction 314B of a second eye 316B of a user), collected by the gaze-tracking means 302. Moreover, the at least one processor 308 is configured to when the movement 310 of the user's gaze is detected, determine a compensatory movement which when implemented by the image stabilization means 304, shifts visual content 312 displayed on the at least one display 306, according to the movement 310 of the user's gaze. Furthermore, the at least one processor 308 is configured to generate a first drive signal for controlling the image stabilization means 304 to implement the compensatory movement, during a frame display time.

It may be understood by a person skilled in the art that FIG. 1 includes a simplified architecture of the display apparatus 300, for sake of clarity, which should not unduly limit the scope of the claims herein. It is to be understood that the specific implementation of the display apparatus 300 is provided as an example and is not to be construed as limiting it to specific numbers or types of gaze-tracking means, image stabilization means, displays, and processors. The person skilled in the art will recognize many variations, alternatives, and modifications of embodiments of the present disclosure.

Referring to FIG. 4, illustrating an optical element 400 arranged on an optical path between at least one display 402 and a user's eye 404, in accordance with an embodiment of the present disclosure. As shown, a wobulator 406 controls the optical element 400 to optically steer light 408 emanating from the at least one display 402 by an angle Δ, to implement a compensatory movement.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method comprising:
detecting a movement of a user's gaze by processing gaze-tracking data, collected by a gaze-tracking means of a display apparatus;
when the movement of the user's gaze is detected, determining a compensatory movement which when implemented by an image stabilization means of the display apparatus, shifts visual content displayed on at least one display of the display apparatus, according to the movement of the user's gaze; and
generating a first drive signal for controlling the image stabilization means to implement the compensatory movement, during a frame display time.

2. The method of claim 1, further comprising:
when the movement of the user's gaze is not detected, generating a second drive signal for controlling the image stabilization means to implement a non-compensatory movement during a display-off time, wherein the non-compensatory movement, when implemented by the image stabilization means, moves the visual content to a predefined default position.

3. The method of claim 1, further comprising:
when the movement of the user's gaze is not detected, generating a third drive signal for controlling the image stabilization means to implement a non-compensatory movement during a display-off time, wherein the non-compensatory movement, when implemented by the image stabilization means, moves the visual content to a position that lies in an opposite direction to the movement of the user's gaze and is at a distance that is equal to twice of a magnitude of the movement of the user's gaze.

4. The method of claim 1, wherein the image stabilization means is implemented as a wobulator, and wherein controlling the wobulator to implement the compensatory movement comprises one of:
physically moving at least one of: the at least one display, an optical element arranged on an optical path between the at least one display and a user's eye, an image sensor of an imaging system for the display apparatus, a lens of the imaging system, such that the visual content is shifted in a direction that is different from a direction of the movement of the user's gaze; or
optically steering light such that the visual content is shifted in a direction that is different from a direction of the movement of the user's gaze.

5. The method of claim 1, wherein the image stabilization means is implemented as a controllable lens, and wherein controlling the controllable lens to implement the compensatory movement comprises adjusting a position of the controllable lens such that the visual content is shifted in a direction that is different from a direction of the movement of the user's gaze.

6. The method of claim 1, wherein the image stabilization means is implemented as a metalens, and wherein controlling the metalens to implement the compensatory movement comprises adjusting a position of the metalens such that the visual content is shifted in a direction that is different from a direction of the movement of the user's gaze.

7. The method of claim 1, wherein the image stabilization means is implemented as a liquid crystal-based element arranged on an optical path between the at least one display and the user's eyes, and wherein controlling the liquid crystal-based element to implement the compensatory movement comprises optically steering light emanating from the at least one display and going towards the user's eyes, such that the visual content is shifted in a direction that is different from a direction of the movement of the user's gaze.

8. A display apparatus comprising:
a gaze-tracking means;
an image stabilization means;
at least one display; and
at least one processor configured to:
detect a movement of a user's gaze by processing gaze-tracking data, collected by the gaze-tracking means;
when the movement of the user's gaze is detected, determine a compensatory movement which when implemented by the image stabilization means, shifts visual content displayed on the at least one display, according to the movement of the user's gaze; and
generate a first drive signal for controlling the image stabilization means to implement the compensatory movement, during a frame display time.

9. The display apparatus of claim 8, wherein the at least one processor is further configured to:
when the movement of the user's gaze is not detected, generate a second drive signal to control the image stabilization means to implement a non-compensatory movement during a display-off time, wherein the non-compensatory movement, when implemented by the image stabilization means, moves the visual content to a predefined default position.

10. The display apparatus of claim 8, wherein the at least one processor is further configured to:
when the movement of the user's gaze is not detected, generate a third drive signal to control the image stabilization means to implement a non-compensatory movement during a display-off time, wherein the non-compensatory movement, when implemented by the image stabilization means, moves the visual content to a position that lies in an opposite direction to the movement of the user's gaze and is at a distance that is equal to twice of a magnitude of the movement of the user's gaze.

11. The display apparatus of claim 8, wherein the image stabilization means is implemented as a wobulator, and wherein to control the wobulator to implement the compensatory movement, the at least one processor is configured to:
physically move at least one of: the at least one display, an optical element arranged on an optical path between the at least one display and a user's eye, an image sensor of an imaging system for the display apparatus, a lens of the imaging system, such that the visual content is shifted in a direction that is different from a direction of the movement of the user's gaze; or
optically steer light such that the visual content is shifted in a direction that is different from a direction of the movement of the user's gaze.

12. The display apparatus of claim 8, wherein the image stabilization means is implemented as a controllable lens, and wherein to control the controllable lens to implement the compensatory movement, the at least one processor is further configured to adjust a position of the controllable lens such that the visual content is shifted in a direction that is different from a direction of the movement of the user's gaze.

13. The display apparatus of claim 8, wherein the image stabilization means is implemented as a metalens, and wherein to control the metalens to implement the compensatory movement, the at least one processor is further configured to adjust a position of the metalens such that the visual content is shifted in a direction that is different from a direction of the movement of the user's gaze.

14. The display apparatus of claim 8, wherein the image stabilization means is implemented as a liquid crystal-based element arranged on an optical path between the at least one display and the user's eyes, and wherein to control the liquid crystal-based element to implement the compensatory movement, the at least one processor is further configured to optically steer light emanating from the at least one display and going towards the user's eyes, such that the visual content is shifted in a direction that is different from a direction of the movement of the user's gaze.
